(19) United States
(12) Patent Application Publication
(10) Pub. No.: US 2013/0063960 A1
(43) Pub. Date: Mar. 14, 2013

(54) VEHICLE LIGHTING APPARATUS

(71) Applicants: Takahiro Nakano, Kariya-city (JP); Daisuke Nishitani, Kariya-city (JP); Tsutomu Kamizono, Nagoya-city (JP); Takahito Nishii, Nagoya-city (JP); Naohito Katoh, Kariya-city (JP)

(72) Inventors: Takahiro Nakano, Kariya-city (JP); Daisuke Nishitani, Kariya-city (JP); Tsutomu Kamizono, Nagoya-city (JP); Takahito Nishii, Nagoya-city (JP); Naohito Katoh, Kariya-city (JP)

(73) Assignee: DENSO CORPORATION, Kariya-city (JP)

(21) Appl. No.: 13/534,032

(22) Filed: Jun. 27, 2012

(30) Foreign Application Priority Data
Sep. 12, 2011 (JP) 2011-198345

(51) Int. Cl. F21V 13/12; F21V 29/00

(52) U.S. Cl. 362/516

(57) ABSTRACT

A vehicle lighting apparatus has a semiconductor light-emitting device, an optical unit for discharging light of the semiconductor light-emitting device toward an irradiated area, a driving circuit portion for supplying electric power to the semiconductor light-emitting device, and a heat radiating portion. The semiconductor light-emitting device is directly attached to the driving circuit portion. The optical unit, the driving circuit portion and the heat radiating portion are assembled together to form a lighting module.

### CROSS REFERENCE TO RELATED APPLICATION

This application is based on Japanese Patent Application No. 2011-198345 filed on Sep. 12, 2011, the disclosure of which is incorporated herein by reference.

### TECHNICAL FIELD

The present invention relates to a vehicle lighting apparatus, in particular, relates to a vehicle lighting apparatus having a light source being composed of a semiconductor light-emitting device (hereinafter referred to as LED).

### BACKGROUND

A vehicle lighting apparatus having an LED as a light source is known in the art, for example, as disclosed in Japanese Patent Publication No. 2011-048923 (A), according to which a lighting characteristic required for the lighting apparatus is realized by use of optical parts and/or components, such as a reflector, a lens, a shade and so on. The optical parts and/or components, such as the reflector, the lens, the shade and so on, are respectively formed as independent parts and/or components. The vehicle lighting apparatus is made up by combining and assembling together those parts and/or components.

As disclosed in the above prior-art patent publication, a driving circuit for supplying electric power to the LED of the light source is generally arranged at such a position, which is separated from the LED, for example, inside or outside of a housing of the lighting apparatus. In other words, the driving circuit is generally formed as a separate component from the LED. A wiring is installed between the LED and the driving circuit for supplying the electric power, when the LED and the driving circuit are formed as the separate components from each other.

When the optical parts and/or components, such as the reflector, the lens, the shade and so on, are formed as the separate and independent parts and/or components, a number of assembling steps for such optical parts and/or components is increased. A manufacturing cost for the vehicle lighting apparatus is increased. In case of the optical parts and/or components, since accuracy of their layouts to each other may have an influence on a lighting characteristic of the vehicle lighting apparatus, it cannot be easily done to simplify the assembling process.

It is necessary to effectively radiate heat generated by the LED, when the LED is used as the light source. Therefore, in the above prior-art patent publication, the LED is attached to a heat sink body so as to radiate the heat generated at the LED to an outside via the heat sink body.

In the above heat radiating method of the patent publication, the heat is transmitted via a limited area of a contacting surface between the LED and the heat sink body. An amount of heat, which can be radiated for a unit time, is limited. In other words, it is difficult in the prior-art lighting apparatus to sufficiently radiate the heat.

### SUMMARY OF THE DISCLOSURE

The present disclosure is made in view of the above problems. It is an object of the present disclosure to provide a vehicle lighting apparatus, according to which a heat radiating performance of the LED (used as the light source) is improved while a possible increase of manufacturing cost is suppressed.

According to a feature of the present invention, a vehicle lighting apparatus has a semiconductor light-emitting device for emitting light upon receiving electric power, an optical unit, and a first metal film formed at apart of a surface area of the reflector portion for reflecting the light. The optical unit is made of translucent material and is integrally composed of a reflector portion for reflecting the light emitted from the semiconductor light-emitting device, a lens portion for discharging the light reflected by the reflecting portion toward an irradiated area, and a shade portion for blocking a part of the light entering the lens portion in order to form the irradiated area in a desired shape.

In the present disclosure, since the reflector portion, the lens portion and the shade portion are integrally formed as one optical unit, it is possible to reduce a number of assembling steps for the vehicle lighting apparatus, when compared with a case in which the reflector portion, the lens portion and the shade portion are respectively formed as independent parts. In other words, a step for assembling the reflector portion, a step for assembling the lens portion and a step for assembling the shade portion can be put together as one step for assembling the optical unit, to thereby reduce the number of the assembling steps for the vehicle lighting apparatus.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view showing a structure of a vehicle lighting apparatus according to a first embodiment of the present disclosure;

FIG. 2 is a schematic top view for explaining a whole structure of the vehicle lighting apparatus of FIG. 1;

FIG. 3 is a schematic view showing a structure of an optical unit of FIG. 1;

FIG. 4 is a schematic top view showing a structure of the optical unit of FIG. 3;

FIG. 5 is a schematic and perspective view of the optical unit of FIG. 3, when viewed in a direction indicated by an arrow V in FIG. 3;

FIG. 6 is a schematic cross sectional view showing a structure of a driving circuit portion of FIG. 1;

FIG. 7 is a schematic cross sectional view showing a vehicle lighting apparatus according to a second embodiment of the present disclosure; and

FIG. 8 is a schematic top view showing a structure of the vehicle lighting apparatus of FIG. 7

### DETAILED DESCRIPTION OF THE EMBODIMENTS

The present invention will be explained by way of multiple embodiments with reference to the drawings.

### First Embodiment

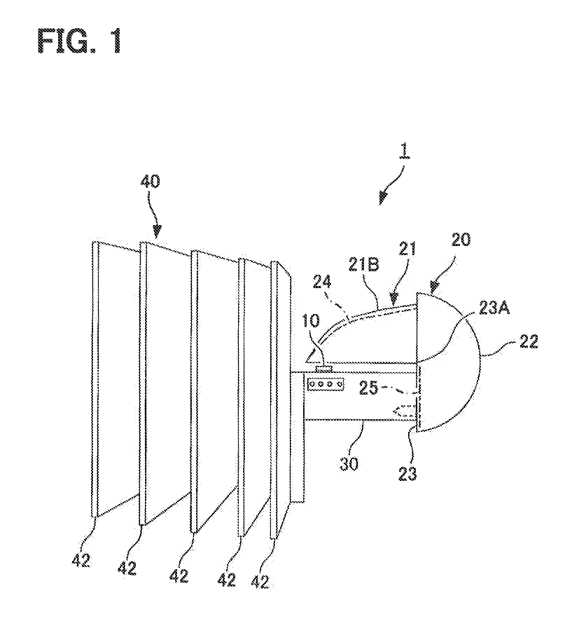

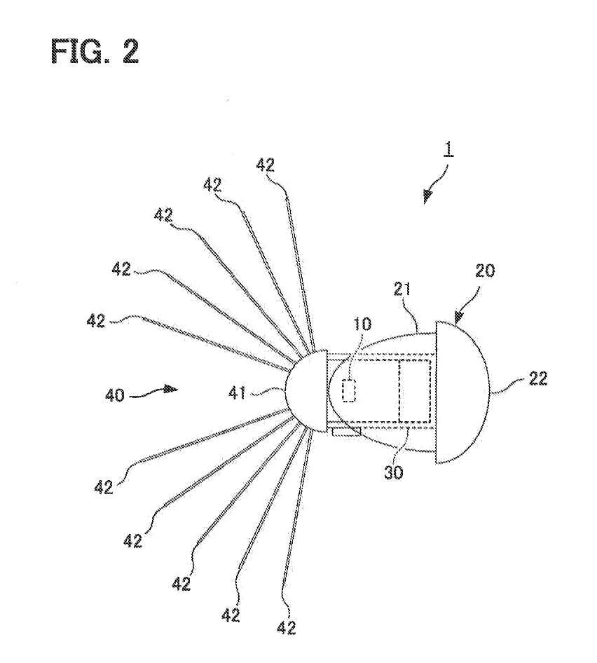

A vehicle lighting apparatus according to a first embodiment of the present disclosure will be explained with reference to FIGS. 1 to 6. FIG. 1 is a schematic view showing a structure of a vehicle lighting apparatus 1 according to the present embodiment. FIG. 2 is a schematic top view for explaining a whole structure of the vehicle lighting apparatus 1 of FIG. 1.

The vehicle lighting apparatus 1 is mounted in a vehicle (for example, an automotive vehicle) for irradiating a desired area, for example, a road surface in front of the vehicle. The present embodiment will be explained, wherein the vehicle lighting apparatus 1 is applied to a head lamp of the vehicle. Hereinafter, a direction in which light is emitted is referred to as a front direction, while an opposite direction is referred to as a rear direction.

As shown in FIGS. 1 and 2, the vehicle lighting apparatus 1 is composed of a semiconductor light-emitting device 10 (hereinafter, the LED 10), an optical unit 20 for passing light emitted from the LED 10 and irradiating the front direction, a driving circuit portion 30 for supplying electric power to the LED 10 so as to emit the light and controlling an operation of emitting the light, a heat radiating portion 40 for radiating heat generated at the LED 10 as well as heat generated at the driving circuit portion 30, and so on.

The LED 10 emits the light when the electric current is supplied from the driving circuit portion 30. Any kind of well-known semiconductor light-emitting device may be used for the LED 10.

The light emitted from the LED 10 enters the optical unit 20 and the light of the LED 10 is discharged toward the road surface in the front direction (in a right-hand direction in FIG. 1). The optical unit 20 is arranged not only at a position close to the LED 10 in a direction in which the light is emitted from the LED 10 (in an upward direction in FIG. 1) but also at a position which is a front end of the vehicle lighting apparatus 1 in the front direction. The optical unit 20 is integrally made of translucent resin having a high permeability of the light, in other words, translucent resin having a low attenuation rate of the light with respect to a wavelength of the light emitted from the LED 10.

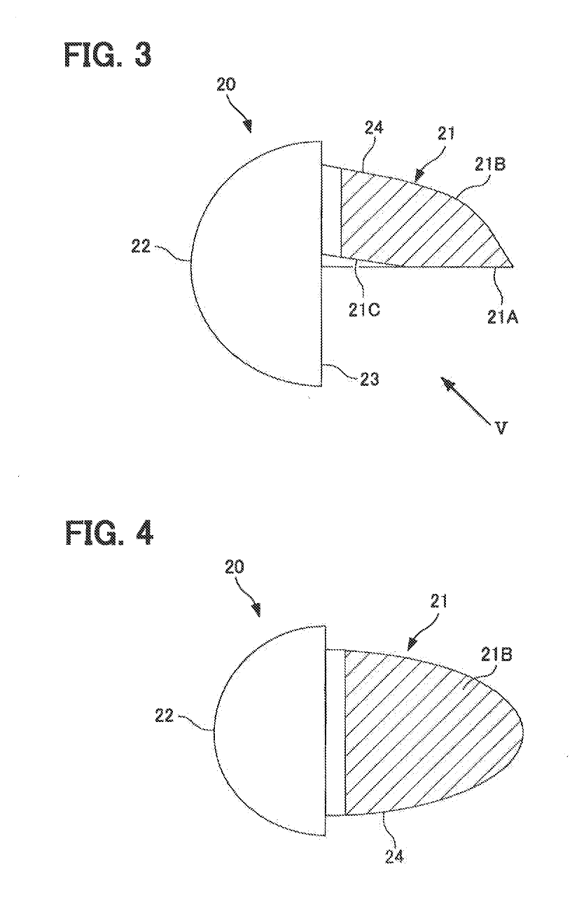

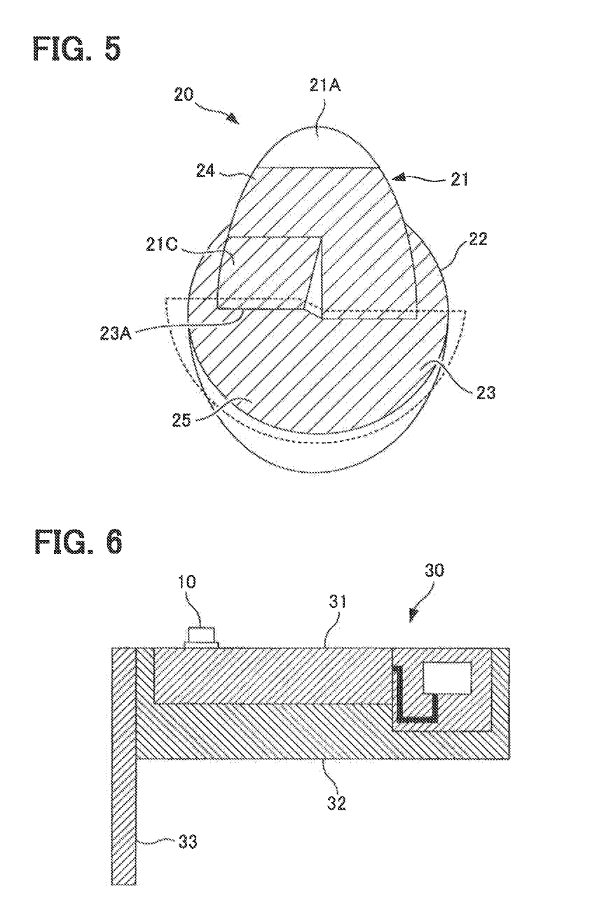

FIG. 3 is a schematic view for explaining a structure of the optical unit 20. FIG. 4 is a schematic top view showing the structure of the optical unit 20 of FIG. 3. FIG. 5 is a schematic perspective view of the optical unit 20 of FIG. 3, when viewed in a direction indicated by an arrow V in FIG. 3.

As shown in FIGS. 3 to 5, the optical unit 20 has a reflector portion 21 for reflecting the light of the LED 10 in the front direction (that is, a left-hand direction in FIG. 3), a lens portion 22 for discharging the light reflected from the reflector portion 21 so as to irradiate the desired area in the front direction, and a shade portion 23 for making a shape of an irradiated area (irradiated by the lens portion 22) in a desired shape.

The reflector portion 21 corresponds to a portion, at which the light emitted from the LED 10 enters the optical unit 20 and which reflects the light from the LED 10 (having entered the optical unit 20) toward the lens portion 22. The reflector portion 21 is also a portion of the optical unit 20, which is projected in the rear direction from an upper side of a rear surface of the lens portion 22. The reflector portion 21 is formed in a dual-partitioning shape wherein an almost conical shape is divided into two parts along a center axial line, or the reflector portion 21 is formed in a shape wherein an ellipsoidal body is divided into four parts along a long axis and a short axis thereof.

The reflector portion 21 has a light entering surface 21A, through which the light emitted from the LED 10 enters the optical unit 20, a reflector mirror surface 21B for reflecting the light of the LED 10 (having entered the optical unit 20) toward the lens portion 22, and a recessed portion 21C for making the irradiated area in the desired shape together with the shade portion 23.

The light entering surface 21A is formed at a flat surface of the reflector portion 21 opposing to the LED 10 (FIG. 1), in other words, at a rear end of a lower side surface. A reflecting metal film 24 (a first metal film 24), which is made of, for example, aluminum, is formed at most of a surface of the reflector portion 21 except for the light entering surface 21A, namely at a hatched area of the surface in FIGS. 3 to 5. In other words, since the reflecting metal film 24 is not formed at the light entering surface 21A, the light emitted from the LED 10 can enter an inside of the reflector portion 21, that is, an inside of the optical unit 20. The light entering surface 21A is located at a position close to the LED 10 (more exactly, a portion of the LED 10 from which the light is emitted), in order to increase a ratio of the light emitted from the LED 10 and entering the optical unit 20.

The reflector mirror surface 215 is formed at a curved surface of the reflector portion 21, which is on a side opposite to the LED 10 (FIG. 1), namely at a curved surface of an upper side surface of the reflector portion 21. The reflecting metal film 24 is formed at an outer surface of the reflector portion 21, so that the light is reflected. The reflector mirror surface 21B is made in such a shape that the light from the LED 10 (which is arranged at a lower side of the reflector portion 21) is reflected toward the lens portion 22 arranged in the front direction. In addition, the reflector mirror surface 21B is made in such a shape that the light reflected by the reflector mirror surface 21B and entering the lens portion 22 has an incident direction and an incident distribution, which is appropriate for irradiating the desired area by the lens portion 22.

The recessed portion 21C is formed in the flat surface (the lower side surface) of the reflector portion 21 opposing to the LED 10 at a front end. More exactly, the recessed portion 21C is formed on a left-hand side of the flat surface (the lower side surface), when viewed in a direction from the rear end toward the front end of the reflector portion 21. The recessed portion 21C is composed of an inclined surface portion inclined in a direction to an upper side of the reflector portion 21 toward the front end thereof and a wall surface portion extending in a vertical direction forming a part of the rear surface of the lens portion 22 and/or forming a part of the shade portion 23.

The recessed portion 21C defines an edge line 23A formed between the flat surface (the lower side surface) of the reflector portion 21 opposing to the LED 10 and the shade surface 23, wherein the edge line 23A defines a shape of a light-blocking area for blocking out a part of the light entering the lens portion 22 from the reflector portion 21. A shape and a location of the recessed portion 21C is changed in various ways depending on the required irradiated area of the vehicle lighting apparatus 1 of respective vehicles. The shape of the recessed portion 21C, therefore, should not be limited to that of the present embodiment.

The lens portion 22 discharges the light, which is reflected by the reflector portion 21 wherein the part of the light is blocked out by the light-blocking area defined by the edge line 23A, to the desired irradiated area in the front direction. The lens portion 22, which is arranged at the front end of the optical unit 20, is integrally formed with the reflector portion 21 and the shade portion 23. A shape of the lens portion 22 is defined by illumination characteristics or the like required for the vehicle lighting apparatus 1.

The shade portion 23 is formed in a lower side area of the rear surface of the lens portion 22. The shade portion 23 defines the edge line 23A together with the recessed portion 21C of the reflector portion 21. A light-blocking metal film 25 (a second metal film 25), which is made of, for example, aluminum, is formed at the rear surfaces of the lens portion 22 and the shade portion 23. The light-blocking metal film 25 made of the metal, which is the same to or different from the metal for the reflecting metal film 24.

FIG. 6 is a schematic cross sectional view showing a structure of the driving circuit portion 30 of FIG. 1.

The driving circuit portion 30 controls power supply of the electric current to the LED 10 and supports the LED 10 and the optical unit 20. As shown in FIGS. 1 and 6, the driving circuit portion 30 is composed of a driving circuit 31, a heat spreader 32 and so on.

The LED 10 is connected to the driving circuit 31 for controlling the power supply of the electric current to the LED 10. The driving circuit 31 is composed of electronic parts and components (not shown), such as an inductor, a filter and so on, for controlling the power supply and a printed-circuit board (not shown) having wiring patterns for electrically connecting the electronic parts and components mounted thereto. In the present embodiment, the LED 10 is mounted to the printed-circuit board.

The heat spreader 32 supports the driving circuit 31 and the optical unit 20. The heat spreader 32 not only radiates the heat generated at the driving circuit 31 and the LED 10 to an outside thereof but also transmits the heat to the heat radiating portion 40. The heat spreader 32 is preferably made of such material having thermal conductivity and mechanical strength, for example, aluminum, aluminum alloy, copper, copper alloy and so on.

A concave portion is formed at an upper side of the heat spreader 32 for accommodating the driving circuit 31. A heat radiating gel is filled in the concave portion between the driving circuit 31 and the heat spreader 32, so that the heat generated at the driving circuit 31 as well as the heat generated at the LED 10 is effectively transmitted to the heat spreader 32. A plate-shape connecting portion 33, which is connected to the heat radiating portion 40, is provided at a rear end of the heat spreader 32.

As shown in FIGS. 1 and 2, the heat generated at the driving circuit 31 and the LED 10, which is transmitted to the heat radiating portion 40 via the heat spreader 32, is radiated to the outside of the vehicle lighting apparatus. The heat radiating portion 40 is composed of a main body 41 connected to the connecting portion 33 of the heat spreader 32 and multiple fins 42 extending from the main body 41 in a radial direction. In the same manner to the heat spreader 32, the main body 41 as well as the fins 42 is preferably made of such material having thermal conductivity and mechanical strength, for example, aluminum, aluminum alloy, copper, copper alloy and so on.

A manufacturing process for the vehicle lighting apparatus 1 will be explained.

The optical unit 20 is made by inletting or injecting the translucent resin into a molding die having a shape corresponding to that of the optical unit 20. Then, the metallic material (such as, aluminum) is coated at predetermined surface portions of the optical unit 20 by a vapor deposition (or by any other methods), so as to form the reflecting metal film 24 and the light-blocking metal film 25.

The driving circuit portion 30 is manufactured after or in parallel to the process for the optical unit 20.

At first, the driving circuit 31 is positioned in the concave portion of the heat spreader 32. The LED 10 is connected in advance to the driving circuit 31 or the LED 10 may be connected to the driving circuit 31 after the driving circuit 31 is arranged in the heat spreader 32.

Then, the optical unit 20 is attached to the heat spreader 32 and the main body 41 of the heat radiating portion 40 is connected to the connecting portion 33 of the heat spreader 32. The heat radiating portion 40 may be, alternatively, in advance connected to the heat spreader 32.

An operation of heat radiation for the vehicle lighting apparatus 1 of the above structure will be explained.

When the electric power is supplied to the LED 10 from the driving circuit 31, the light is emitted from the LED 10 and the heat is generated at the LED 10. At the same time, the heat is generated at the driving circuit 31 for supplying the electric power. The heat generated at the LED 10 and the driving circuit 31 is transmitted to the heat radiating portion 40 via the heat spreader 32 and radiated into the air surrounding the multiple fins 42.

A part of the heat generated at the LED 10 is also transmitted as heat of radiation to the reflector portion 21 of the optical unit 20, which is arranged at the position opposing to the LED 10. The heat of the LED 10 transmitted to the reflector portion 21 is radiated to the outside not only via the outer surface and the reflecting metal film 24 of the reflector portion 21, but also via the outer surfaces of the lens portion 22 and the shade portion 23 as well as the light-blocking metal film 25.

According to the above structure, the reflector portion 21, the lens portion 22 and the shade portion 23 are integrally formed so as to form the optical unit 20. Therefore, a number of assembling steps for the vehicle lighting apparatus 1 can be reduced, when compared with the case in which the reflector portion 21, the lens portion 22 and the shade portion 23 are respectively formed as independent parts. In other words, a step for assembling the reflector portion 21, a step for assembling the lens portion 22 and a step for assembling the shade portion 23 can be put together to one assembling step for the optical unit 20. As a result, it is possible to suppress an increase of the manufacturing cost for the vehicle lighting apparatus 1.

The thermal conductivity of the translucent material is generally larger than that of the air. The optical unit 20 is formed as a solid body made of the translucent material. Therefore, a heat radiating performance can be increased when compared with a case in which the optical unit was formed as a hollow body made of the translucent material. In other words, an amount of the heat, which is generated at the LED 10 and radiated via the optical unit 20 can be increased. As a result, the heat radiating performance for the LED 10 can be improved.

The reflecting metal film 24, which is made of the material having the higher heat conductivity than the translucent material, is formed in the light reflecting area of the reflector portion 21. In a similar manner, the light-blocking metal film 25, which is made of the material having the higher heat conductivity than the translucent material, is formed in the light-blocking area of the shade portion 23. The heat radiating performance of the optical unit 20 is thereby further increased. As a result, the heat radiating performance for the LED 10 can be further improved.

In addition, the optical unit 20 is formed as the solid body made of the translucent material. It is, thereby, possible to avoid a situation that a product lifetime of the LED 10 may be shortened by solar light. More in detail, the solar light causes the LED 10 to deteriorate quickly and thereby the product lifetime may be shortened. The solar light is irradiated to the LED 10 via the optical unit 20. The solar light passes through the solid optical unit made of the translucent material and enters the LED 10. The light attenuation becomes larger when the solar light passes through the translucent material, when compared with a case in which the solar light passes in the air. Accordingly, a ratio of the solar light entering the LED 10 can be decreased, so that a possible shortening of the product lifetime can be suppressed.

In the present embodiment, since the LED 10 is arranged in the driving circuit portion 30, in other words, the LED 10 is directly connected to the driving circuit portion 30, it is further possible to reduce the number of assembling steps for the vehicle lighting apparatus 1, when compared with a case in which the LED 10 is provided at such a position separated from the driving circuit portion 30. As a result, it is possible to suppress the increase of the manufacturing cost for the vehicle lighting apparatus 1.

In the case that the LED 10 is arranged at the position separated from the driving circuit portion 30, it becomes necessary to provide a wiring for supplying the electric power from the driving circuit portion 30 to the LED 10. Therefore, when the LED 10 is directly connected to the driving circuit portion 30, it is possible to eliminate such wiring.

In the present embodiment, the optical unit 20 and the driving circuit portion 30 are assembled together and can be treated as one lighting module. Accordingly, it is possible to reduce the number of assembling steps for the vehicle lighting apparatus 1, when compared with a case in which the optical unit 20 and the driving circuit portion 30 are formed as independent components. As above, it is possible to suppress the increase of the manufacturing cost for the vehicle lighting apparatus 1.

### Second Embodiment

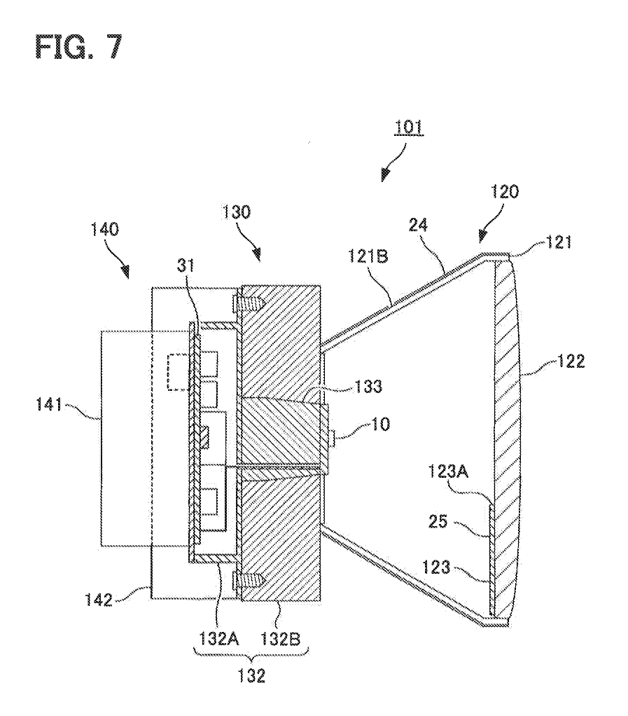

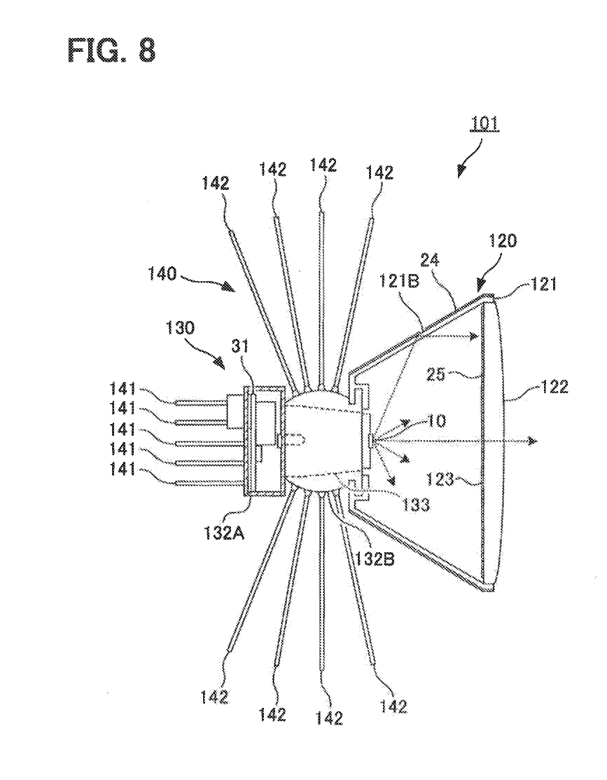

A vehicle lighting apparatus according to a second embodiment of the present disclosure will be explained with reference to FIGS. 7 and 8. FIG. 7 is a schematic cross sectional view showing a vehicle lighting apparatus 101 according to the second embodiment. FIG. 8 is a schematic top view showing a structure of the vehicle lighting apparatus 101 of FIG. 7.

As shown in FIGS. 7 and 8, the vehicle lighting apparatus 101 is composed of the LED 10, an optical unit 120 for passing the light emitted from the LED 10 and irradiating the front direction, a driving circuit portion 130 for supplying the electric power to the LED 10 so as to emit the light and controlling an operation thereof for emitting the light, a heat radiating portion 140 for radiating heat generated at the LED 10 and the driving circuit portion 130, and so on.

The light emitted from the LED 10 enters the optical unit 120 and the light of the LED 10 is discharged toward the road surface in the front direction (in a right-hand direction in FIG. 7). The optical unit 120 differs from the optical unit 20 of the first embodiment in that a direction of the light emitted from the LED 10 and a direction of the light discharged from the optical unit 120 are the same to each other.

The optical unit 120 has a reflector portion 121, a lens portion 122 and a shade portion 123. As in the same manner to the first embodiment, the reflector portion 121, the lens portion 122 and the shade portion 123 are made of the translucent resin and integrally formed as one unit. However, the optical unit 120 differs from the optical unit 20 of the first embodiment in that the optical unit 120 is formed in a hollow structure, in other words, an empty space is formed in the inside of the optical unit 120.

The reflector portion 121 corresponds to a portion for reflecting the light, which is emitted from the LED 10 and diffused, toward the lens portion 122. The reflector portion 121 is formed in a tubular shape, for example, in a conical shape, in a quadrangular pyramid shape or the like, wherein a distance between opposing side walls becomes larger in a direction from a rear side to a front side.

The reflector portion 121 supports at its front side the lens portion 122 and the shade portion 123. The rear side of the reflector portion 121 is fixed to the driving circuit portion 130. More exactly, the reflector portion 121 holds tight a portion of the driving circuit portion 130.

A side-wall surface of the reflector portion 121 functions as a reflector mirror surface 121B. The reflecting metal film 24 is formed at the reflector mirror surface 121B. The reflector mirror surface 121B is such an inclined surface, wherein a distance between the opposing side-wall surfaces is gradually increased as the side-wall surface is further away from the LED 10 in the direction from the rear side to the front side. Accordingly, the reflector portion 121 reflects the diffused light from the LED 10 toward the lens portion 122 (as indicated by dotted lines in FIG. 8).

As shown in FIGS. 7 and 8, the reflecting metal film 24 is formed at an outside surface of the reflector mirror surface 121B, in other wards, at an outside of the optical unit 120. However, the reflecting metal film 24 may be formed at an inside surface of the reflector mirror surface 121B (at an inside of the optical unit 120).

The lens portion 122 discharges the light which has directly entered the lens portion 122 as well as the light which is reflected by the reflector portion 121, to the desired irradiated area in the front direction. The lens portion 122 is supported by the front side of the reflector portion 121. The shade portion 123 is integrally formed with the lens portion 122. As in the same manner to the lens portion 22 of the first embodiment, a shape of the lens portion 122 is defined by the illumination characteristics or the like required for the vehicle lighting apparatus 101.

The shade portion 123 is formed at a rear surface of the lens portion 122 in a lower side area thereof. The shade portion 123 extends in a horizontal direction of the lower side area. The light-blocking metal film 25 is formed on the rear surface of the lens portion 122 to form the shade portion 123. An upper end of the light-blocking metal film 25 defines an edge line 123A, so that the irradiated area required for the vehicle lighting apparatus 101 is realized by partly blocking the light.

In the present embodiment, the light-blocking metal film 25 is formed at the rear surface of the lens portion 122, in other words, in the inside of the optical unit 120. However, the light-blocking metal film 25 may be formed at a front surface of the lens portion 122 (at the outside of the optical unit 120).

The driving circuit portion 130 controls power supply of the electric current to the LED 10 and supports the LED 10 and the optical unit 120. As shown in FIGS. 7 and 8, the driving circuit portion 130 is composed of the driving circuit 31, a heat spreader 132 and a heat transmitting member 133.

The heat spreader 132 is composed of a first heat spreading portion 132A for supporting the driving circuit 31 and a second heat spreading portion 132B for supporting the optical unit 120. The heat spreader 132 (including the first and second heat spreading portions 132A and 132B) is preferably made of such material having thermal conductivity and mechanical strength, for example, aluminum, aluminum alloy, copper, copper alloy and so on. The first and second heat spreading portions 132A and 132B are fixed to each other, for example, by means of screws, so that the heat can be transmitted from one to the other.

A space for accommodating the driving circuit 31 is provided in an inside of the first heat spreading portion 132A. The first heat spreading portion 132A is connected to the heat transmitting member 133, so that the heat can be transmitted from one to the other. In the present embodiment, the first heat spreading portion 132A is directly fixed to the heat transmitting member 133.

The second heat spreading portion 132B is provided between the first heat spreading portion 132A and the optical unit 120, so as to support the optical unit 120. A through-hole is formed in the second heat spreading portion 132B and the heat transmitting member 133 is inserted into the through-hole. The heat transmitting member 133 is made of the material having a high heat transmitting performance. The LED 10 is provided at a front end of the heat transmitting member 133. A rear end surface of the heat transmitting member 133 is directly in contact with the first heat spreading portion 132A. Wires are provided in the heat transmitting member 133 for supplying the electric power from the driving circuit 31 to the LED 10.

As shown in FIGS. 7 and 8, the heat radiating portion 140 is composed of multiple first fins 141 connected to the first heat spreading portion 132A and multiple second fins 142 connected to the second heat spreading portion 132B. The heat of the driving circuit 31 as well as the heat of the LED 10, which is transmitted to the heat spreader 132, is radiated to the outside of the vehicle lighting apparatus 101 via the first and second fins 141 and 142.

Each of the first fins 141 is formed in a plate shape extending from the first heat spreading portion 132A in the rear direction, wherein the multiple first fins 141 are arranged in parallel to one another. Each of the second fins 142 is likewise formed in a plate shape extending from the second heat spreading portion 132B in a left-hand direction and in a right-hand direction (in an upper and a lower direction in FIG. 8), in other words, in a radial direction from the second heat spreading portion 132B.

A manufacturing process for the vehicle lighting apparatus 101 of the above structure will be explained.

The reflector portion 121 and the lens portion 122 are made by inletting or injecting the translucent resin into respective molding dies, each having a shape corresponding to that of the reflector portion 121 and the lens portion 122.

Then, the reflecting metal film 24 is formed at a predetermined surface area of the reflector portion 121, while the light-blocking metal film 25 is formed at a predetermined surface area of the lens portion 122. The lens portion 122 is then fixed to the front end of the reflector portion 121 so as to complete the optical unit 120.

The driving circuit portion 130 is manufactured after or in parallel to the process for the optical unit 120.

The first heat spreading portion 132A and the second heat spreading portion 132B are connected to each other, for example, by screws or the like. In this process, the heat transmitting member 133 is assembled into the through-hole of the second heat spreading portion 132B. The heat transmitting member 133 is formed in a tapered shape, an outer diameter of which is reduced toward its front side. The through-hole of the second heat spreading portion 132B is also formed in a tapered shape having an inner diameter, which is reduced toward its front side. As above, the heat transmitting member 133 is tightly held between the first and second heat spreading portions 132A and 132B. Then, the LED 10 is connected to the front end of the heat transmitting member 133.

The driving circuit 31 is accommodated in the inside of the first heat spreading portion 132A, after the first and second heat spreading portions 132A and 132B are connected to each other. The driving circuit 31 is wired to the LED 10. The optical unit 120 is integrally assembled to the driving circuit portion 130, to thereby complete the vehicle lighting apparatus 101.

An operation of heat radiation for the vehicle lighting apparatus 101 of the above structure will be explained.

When the electric power is supplied to the LED 10 from the driving circuit 31, the light is emitted from the LED 10 and the heat is generated at the LED 10. At the same time, the heat is generated at the driving circuit 31 for supplying the electric power.

The heat generated at the LED 10 is transmitted to the second heat spreading portion 132B via the heat transmitting member 133 and further transmitted to the first heat spreading portion 132A via the heat transmitting member 133 and the second heat spreading portion 132B. The heat transmitted to the second heat spreading portion 132B is radiated into the surrounding air via the second fins 142, while the heat transmitted to the first heat spreading portion 132A is radiated into the surrounding air via the first fins 141. The heat generated at the driving circuit 31 is radiated into the surrounding air via the first heat spreading portion 132A and the first fins 141.

According to the above structure, the heat generated at the LED 10 can be easily transmitted to the heat radiating portion 140 via the heat transmitting member 133. In other words, the LED 10 is thermally connected to the heat radiating portion 140, to thereby improve the heat radiating performance for the LED 10.

In the present embodiment, the optical unit 120 and the driving circuit portion 130 are assembled together so that it can be treated as one lighting module. Accordingly, it is possible to reduce the number of assembling steps for the vehicle lighting apparatus 101, when compared with a case in which the optical unit 120 and the driving circuit portion 130 are formed as independent components.

What is claimed is:

1. A vehicle lighting apparatus comprising:
a semiconductor light-emitting device for emitting light upon receiving electric power;
an optical unit made of translucent material, the optical unit being integrally composed of a reflector portion for reflecting the light emitted from the semiconductor light-emitting device, a lens portion for discharging the light reflected by the reflector portion toward an irradiated area, and a shade portion for blocking a part of the light entering the lens portion in order to form the irradiated area in a desired shape; and
a first metal film formed at a part of a surface area of the reflector portion for reflecting the light.

2. The vehicle lighting apparatus according to claim 1, further comprising;
a second metal film formed in the shade portion at such a surface area thereof for blocking the part of the light in order to form the irradiated area in the desired shape.

3. The vehicle lighting apparatus according to claim 1, further comprising;
a driving circuit portion for supplying the electric power to the semiconductor light-emitting device,
wherein the semiconductor light-emitting device is arranged in the driving circuit portion.

4. The vehicle lighting apparatus according to claim 1, further comprising;
a driving circuit portion for supplying the electric power to the semiconductor light-emitting device;
a heat radiating portion thermally connected to the driving circuit portion so that heat generated at the driving circuit portion is radiated into surrounding air; and
a heat transmitting member provided between the semiconductor light-emitting device and the heat radiating portion for transmitting heat generated at the semiconductor light-emitting device to the heat radiating portion.

5. The vehicle lighting apparatus according to claim 4, wherein
the semiconductor light-emitting device is thermally connected to the heat transmitting member.

6. The vehicle lighting apparatus according to claim 3, wherein
the optical unit and the driving circuit portion are assembled together to form a lighting module.

7. The vehicle lighting apparatus according to claim 1, wherein
the reflector portion, the lens portion and the shade portion of the optical unit are made of the translucent material and formed as one solid body.

8. The vehicle lighting apparatus according to claim 3, further comprising;
a heat radiating portion having multiple fins thermally connected to the driving circuit portion.

9. A vehicle lighting apparatus comprising:
a semiconductor light-emitting device for emitting light upon receiving electric power;
an optical unit for discharging the light from the semiconductor device toward an irradiated area;
a driving circuit portion for accommodating a driving circuit, which supplies the electric power to the semiconductor light-emitting device; and
a heat radiating portion thermally connected to the driving circuit portion so that heat generated at the driving circuit portion is radiated into surrounding air,
wherein the optical unit is made of translucent material as one solid body and includes;
a reflector portion for reflecting the light emitted from the semiconductor light-emitting device;
a lens portion for discharging the light from the semiconductor light-emitting device to the irradiated area; and
a shade portion formed at the lens portion for blocking a part of the light entering the lens portion in order to form the irradiated area in a desired shape,
wherein the semiconductor light-emitting device is directly and thermally connected to the driving circuit portion, so that heat generated at the semiconductor light-emitting device is radiated into surrounding air via the heat radiating portion.

10. A vehicle lighting apparatus comprising:
a semiconductor light-emitting device for emitting light upon receiving electric power;
an optical unit for discharging the light from the semiconductor light-emitting device toward an irradiated area;
a driving circuit portion for supplying the electric power to the semiconductor light-emitting device;
a heat radiating portion thermally connected to the driving circuit portion so that heat generated at the driving circuit portion is radiated into surrounding air,
wherein the optical unit includes;
a reflector portion for reflecting the light emitted from the semiconductor light-emitting device;
a lens portion fixed to the reflector portion at a front end thereof; and
a shade portion formed at the lens portion for blocking a part of the light entering the lens portion in order to form the irradiated area in a desired shape,
wherein the driving circuit portion includes;
a first heat spreading portion for accommodating a driving circuit for supplying the electric power to the semiconductor light-emitting device;
a second heat spreading portion connected at a rear side thereof to the first heat spreading portion and supporting a rear end of the reflector portion; and
a heat transmitting member provided in the second heat spreading portion in such a manner that a rear end of the heat transmitting member is thermally connected to the first heat spreading portion,
wherein the semiconductor light-emitting device is thermally connected to a front end of the heat transmitting member.

11. The vehicle lighting apparatus according to claim 10, further comprising;
multiple first fins connected to the first heat spreading portion; and
multiple second fins connected to the second heat spreading portion.
